(19) United States
(12) Patent Application Publication
(10) Pub. No.: US 2017/0109331 A1
(43) Pub. Date: Apr. 20, 2017

(54) MANAGING CHANGES TO A DOCUMENT IN A REVISION CONTROL SYSTEM

(71) Applicant: International Business Machines Corporation, Armonk, NY (US)

(72) Inventors: Simone Bonazzoli, Castle Gandolfo (IT); Marco Borgianni, Roma (IT); Claudio Falcone, Rome (IT); Alessio Fioravanti, Rome (IT); Giuseppe Longobardi, Naples (IT); Silvano Lutri, Rome (IT); Luigi Presti, L'Aquila (IT); Paolo Salerno, Monterotondo (IT); Alessandro Tomasi, Aprilia (IT); Francesca Ziantoni, Vicovaro (IT)

(21) Appl. No.: 14/884,810

(22) Filed: Oct. 16, 2015

(51) Int. Cl. G06F 17/22; G06F 3/0484; G06F 17/21; G06F 17/27; G06F 17/24

(52) U.S. Cl. CPC G06F 17/2288; G06F 17/2705; G06F 17/245; G06F 17/2211; G06F 17/218; G06F 17/2252; G06F 3/0484

(57) ABSTRACT

A computer-implemented method includes identifying a document accessible to a revision control system. The method identifies at least two document versions for the document. The method receives a plurality of critical artefacts. The method parses each of the at least two document versions for the plurality of critical artefacts to yield a critical artefact table for each of the at least two document versions. The method compares the critical artefact table for a first document versions with the critical artefact table for a second document versions. The method identifies one or more corresponding critical artefacts from the first version and the second version. The method compares each document version to yield a set of differences between the at least two document versions. The method organizes the set of differences between the at least two document versions based on the one or more corresponding critical artefacts.

### BACKGROUND

The present invention relates generally to the field of information technology and more particularly to code change management systems.

Several types of documents (for example, software programs in source code) are changed over time (for example, to correct errors, to add features, to improve performance, to increase security, to comply with new requirements). Managing changes made to those documents may be critical to applications utilizing those documents.

Revision control systems are available to automate or semi-automate the management of changes to documents. For example, the revision control systems may save different versions of the same document in compressed format, locking the documents, structuring the different versions (for example, with branches and merges), accounting for the ownership of changes, resolving conflicts between different changes, defining baseline versions, rolling back to previous versions, and exporting the different versions.

Revision control systems and revision control system developers may face difficulties when managing large documents (for example, complex software programs) with a high number of changes being made. Revision control systems and revision control system developers may face difficulty identifying specific changes that may be of interest to a user or developer, when such changes are mixed with many other changes and the risk of overlooking some changes that might instead be relevant is quite high.

### SUMMARY

A computer-implemented method includes identifying a document. The document is accessible to a revision control system. The method identifies at least two document versions. The at least two document versions are for the document. The at least two document versions are accessible to the revision control system. The method receives a plurality of critical artefacts. The method parses each of the at least two document versions for the plurality of critical artefacts to yield a critical artefact table for each of the at least two document versions. The method compares the critical artefact table for a first version of the at least two document versions with the critical artefact table for a second version of the at least two document versions. The method identifies one or more corresponding critical artefacts. The one or more corresponding critical artefacts are referenced from both the critical artefact table for the first version and the critical artefact table for the second version. The method compares each of the at least two document versions to yield a set of differences between the at least two document versions. The method organizes the set of differences between the at least two document versions based on the one or more corresponding critical artefacts. A corresponding computer program product and computer system are also disclosed.

### BRIEF DESCRIPTION OF THE DRAWINGS

FIG. 1 is a schematic diagram of a computing machine suitable for operation of a revision control system, in accordance with at least one embodiment of the invention.

FIG. 2 is a functional block diagram of a revision control system, in accordance with at least one embodiment of the present invention.

FIG. 3 is a functional block diagram of another aspect of a revision control system, in accordance with at least one embodiment of the present invention.

FIG. 4 is a block diagram displaying various logical components of a revision control system, in accordance with at least one embodiment of the present invention.

FIG. 5 is a control flow diagram for a revision control system, in accordance with at least one embodiment of the present invention.

FIG. 6 is a control flow diagram for another aspect of a revision control system, in accordance with at least one embodiment of the present invention.

FIG. 7 is a control flow diagram for another aspect of a revision control system, in accordance with at least one embodiment of the present invention.

FIG. 8 is a block diagram of a computing apparatus suitable for executing the revision control system, in accordance with at least one embodiment of the present invention.

### DETAILED DESCRIPTION

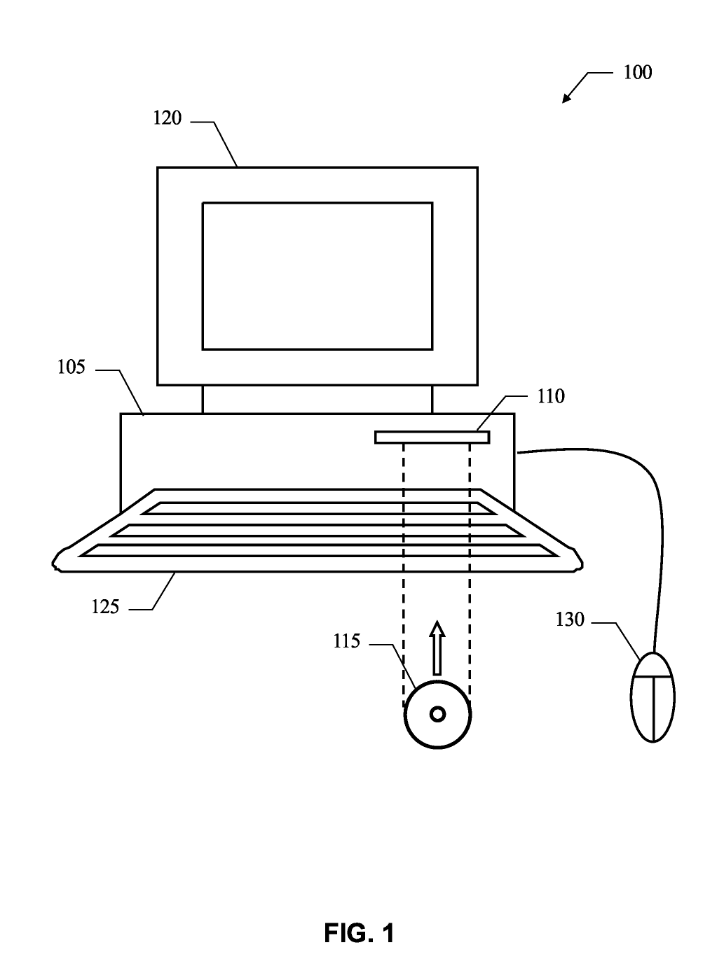

Referring now to the invention in more detail, FIG. 1 is a block diagram displaying a computing machine 100 that may suitable for operation of the present invention.

The computing machine 100 may be a Personal Computer (PC). The computing machine 100 may include a central unit 105. The central unit 105 houses electronic circuits (not shown) controlling operation of the computing machine 100. In some embodiments, the electronic circuits include a microprocessor, a working memory, and drives for input/output units. The electronic circuits may be implemented within the computing machine 100 by integrated components mounted on a mother board and connected to a daughter board. The personal computer 100 may also communicate with a hard-disk (not shown) and a drive 110. The personal computer may access the drive 100 and/or the hard-disk to read optical disks 115. The optical disks 115 may be CDs or DVDs. The computing machine 100 includes a monitor 120. The monitor 120 may be used to display images, documents, or other information resources. The computing machine 100 may respond to input from a keyboard 125 and/or a mouse 130. The keyboard 125 and the mouse 130 are in mutual communication with the computing machine 100 via the central unit 105. In some embodiments, user may operate the personal computer 100 via the keyboard 125 and/or the mouse 130. The computing machine 100 communicates with a revision control system (not shown).

The revision control system is a system for automatically and/or semi-automatically storing, retrieving, logging, identifying, and/or merging revisions. The revision control system may access and/or edit documents, images, or other information resources stored within the computing machine 100 and/or the working memory within the computing machine 100.

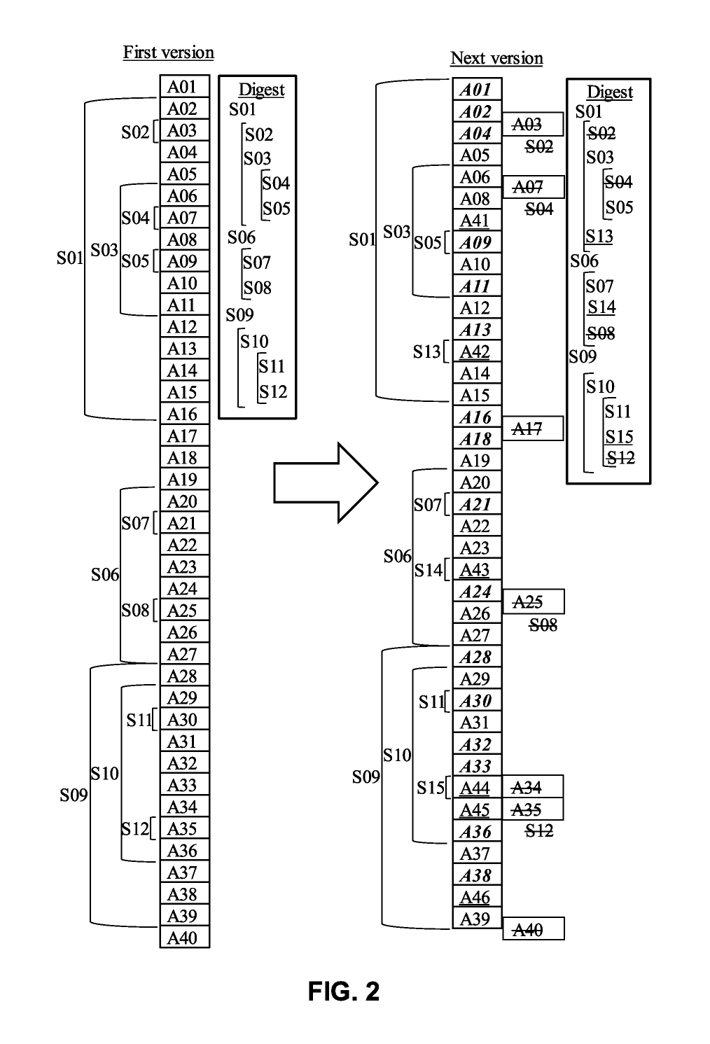

FIG. 2 is an exemplary illustration of the revision control system. In some embodiments, the computing machine 100 may manage changes to a document. For example, the revision control system may manage changes to source code for a software program. A software program has a plurality of different versions that have been provided over time during its life cycle; the versions are ordered temporarily in a sequence, wherein each next version (different from the first version) is directly preceded by a corresponding previous version. Each version (stored in one or more files) is formed by a collection of artefacts (for example, instructions written in a corresponding programing language like C++).

In some embodiments, a first version of a document comprises the artefacts A01-A40. The corresponding next version has been changed by modifying the artefacts A01, A02, A04, A09, A11, A13, A16, A18, A21, A24, A28, A30, A32, A33, A36 and A38 (bold italic), removing the artefacts A03, A07, A17, A25, A34, A35 and A40 (struck through) and adding new artefacts A41, A42, A43, A44, A45 and A46 (underlined).

In such an embodiment, each version is analyzed against one or more snippet definitions; the one or more snippet definitions relate to components of the software program that are likely to be critical for aspects of the software program. In some embodiments, the one or more snippet definitions may be of interest to a user. For example, the one or more snippets may be routine declarations, variable declarations, or main programming constructs for features of the software program. This analysis identifies one or more snippets of the version, each one compliant with a corresponding snippet definition. The snippets of each subsequent version are compared with the snippets of the previous version and/or previous versions. Each comparison identifies each snippet within a next version corresponding to one of the snippets of the previous version, each snippet of the previous version that has been deleted in the next version and each snippet of the next version that has been added to the snippets of the previous version. In this way, the snippets of each version define a sort of digest thereof (at the level of logical units formed by its snippets), with the corresponding snippets in the different versions that are aligned one to another.

In such an embodiment, the first version comprises the snippet SO1 (which encloses the snippet SO2 and the snippet S03, which in turn encloses the snippets SO4 and S05), the snippet S06 (which encloses the snippets S07 and S08) and the snippet S09 (which encloses the snippet S10, which in turn encloses the snippets S12 and S13). The corresponding next version comprises the same snippets S01, S03, S05, S06, S07, S09, S10 and S11, whereas the snippets S02, S04, S08 and S12 (struck through) have been deleted and new snippets S13, S14 and S15 (underlined) have been added.

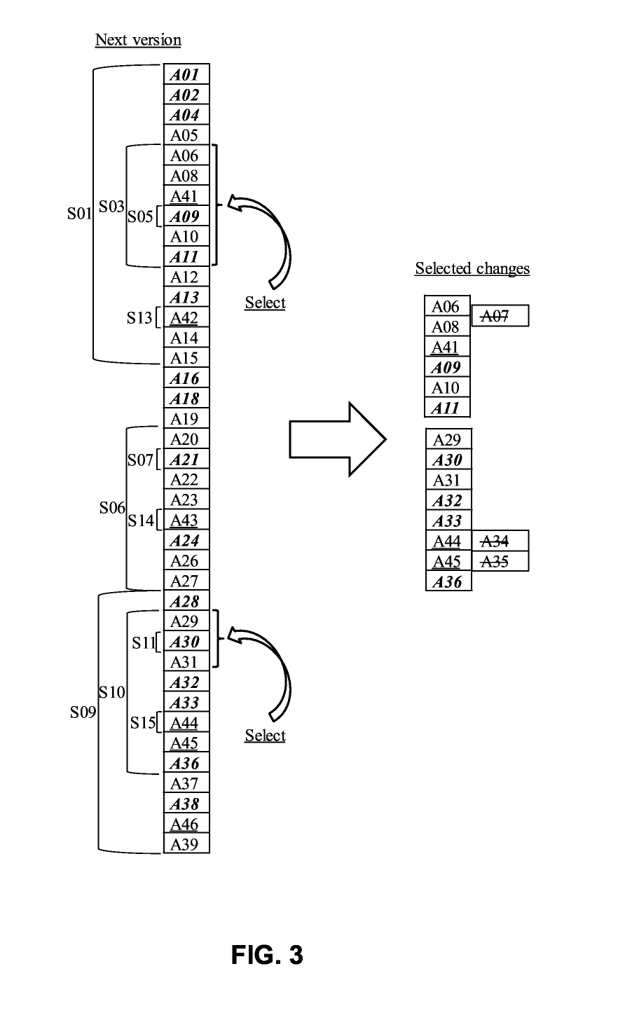

FIG. 3 is an exemplary illustration of the revision control system. FIG. 3 illustrates selecting one or more portions of a selected version. In some embodiments, the one or more portions are selected by a user, such as a program developer. In such embodiments, the selected versions may be related to a feature thereof for which the user is interested in tracking the corresponding changes. The revision control system may be responsive to one or more selected snippets are determined to be among the snippets of the selected version. Each selected snippet is determined as the snippet that directly encloses the corresponding selected portion (i.e., the smallest snippet). One or more selected changes may be determined to be between the snippets corresponding to the selected snippets in each (one or more) pair of comparison versions. For example, each pair of adjacent versions from the selected version back to the first version. An indication of the selected changes is then output to the user (for example, on the monitor of the personal computer).

In such an embodiment, the user selects the portions of the next version formed by the artefacts A06-A11 and by the artefacts A29-A31 (for example, relating to the implementation of a specific feature of the software program, such as a login procedure, a security check, a payment transaction); the selected snippets enclosing these selected portions A06-A11 and A29-A31 are S03 and S10, respectively. The selected changes between the snippets S03, S10 of the next version and the same snippets S03, S10 of the first versions are then shown. The user may see the changes (between the next version and the first version) that relate to the feature of interest comprise the modification of the artefacts A9, A11, A30, A32, A33, A36, the deletion of the artefacts A07, A34, A35 and the addition of the artefacts A41, A44, A45.

In some embodiments, changes only relate to the selected portions identified by the user for the aspect of interest (whereas in other embodiments, all the other changes are disregarded). In such embodiments, selected changes are pruned for information that is likely to be of low value. In this way, a user is provided with a reduced amount of information. In such an embodiment, the selected changes are determined for the selected snippets enclosing the selected portions (and not only for them). Further information that might be critical for the aspect of interest may be added.

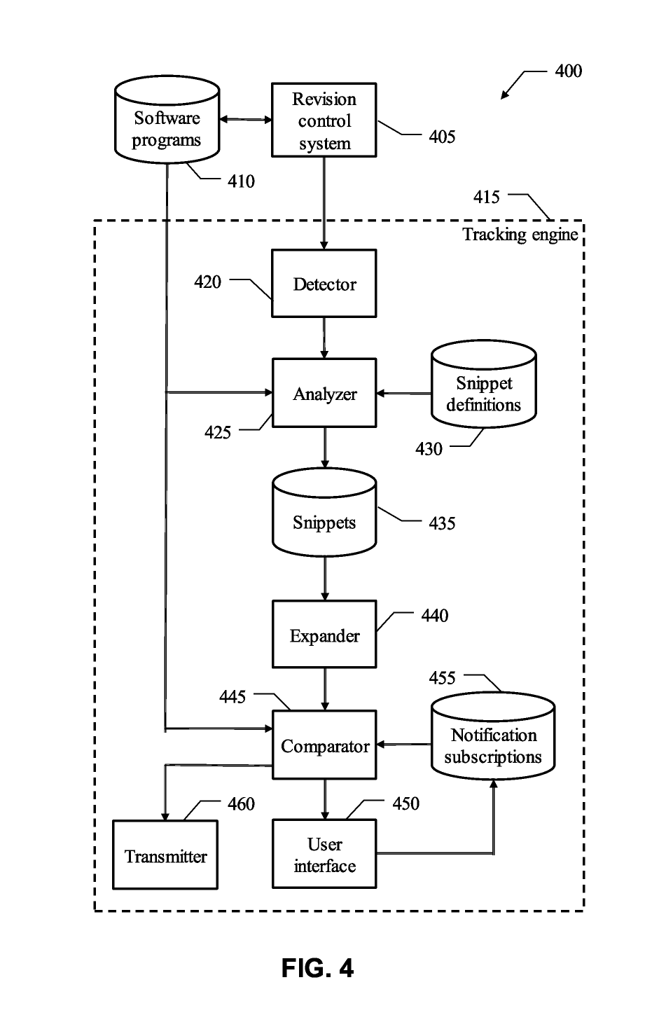

FIG. 4 is an exemplary illustration of software components that may be used to implement a revision control system in accordance with at least one embodiment of the present invention.

All software components within FIG. 4 (programs and data) are denoted as a whole with the reference 400. The software components 400 are typically stored in the mass memory and loaded (at least partially) into the working memory of the computing machine 100. Programs, such as the revision control system, are initially installed into the working memory, for example, from removable storage units or from a network (such as the Internet). In this respect, each software component may represent a module, segment or portion of code, which comprises one or more executable instructions for implementing a specified logical function for the revision control system.

A revision control system (or code/source management system) 405 is used to automate (at least in part) the management of changes to software programs; for example, the revision control system 405 is part of a larger Software Configuration Management (SCM) system that is used to control consistency of performance, functionality, requirements, design and documentation of software programs throughout their entire life cycle (for example, IBM Rational ClearCase by IBM Corporation—trademarks). The revision control system 405 controls (in read/write mode) a software program repository 410 that stores one or more versions of each software program under management (in source code); generally, each version is stored in association with additional information (for example, provided in corresponding metadata) that may be useful for its management (for example, the person who made each change and when it was made).

In some embodiments, a tracking engine 415 is added to implement the above-mentioned tracking of changes of interest. In such an embodiment, the tracking engine 415 comprises a detector 420, which interacts with the revision control system 405 to detect the uploading of any new version of the software program. The detector 420 controls an analyzer 425 for analyzing each version of the software programs under management against the snippet definitions and for comparing the snippets of each next version with the snippets of the corresponding previous version. For this purpose, the analyzer 425 accesses (in read mode only) the software program repository 410 and a snippet definition repository 430 storing the snippet definitions; in turn, the analyzer 425 controls (in read/write mode) a snippet repository 435, which stores the digest of each version of the software programs under management as defined by its snippets. An expander 440 accesses (in read mode only) the snippet repository 435 for determining the selected snippets corresponding to the selected portions. The expander 440 controls a comparator 445, which accesses (in read mode only) the software program repository 410 for determining the selected changes corresponding to the selected snippets. The comparator 445 interacts with a user interface 450 for selecting (by users of the tracking engine 415) the selected portions and for outputting the corresponding selected changes. The comparator 445 further accesses (in read mode only) a notification subscription repository 455, which stores a definition of notification subscriptions of the users for notifications of changes relating to (further) selected portions of interest (triggered by the detector 420, whose connection is not shown in the figure for the sake of clarity); the notification subscription repository 455 is controlled (in read/write mode) by the user interface 450. The comparator 445 further controls a transmitter 460 for transmitting the required notifications to the corresponding users.

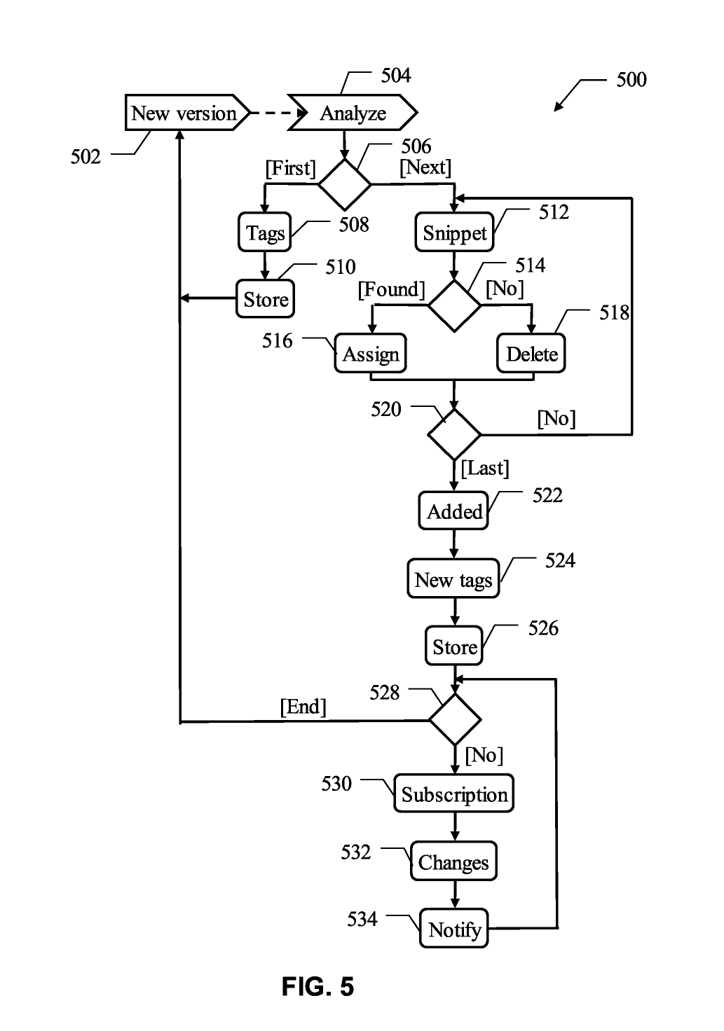

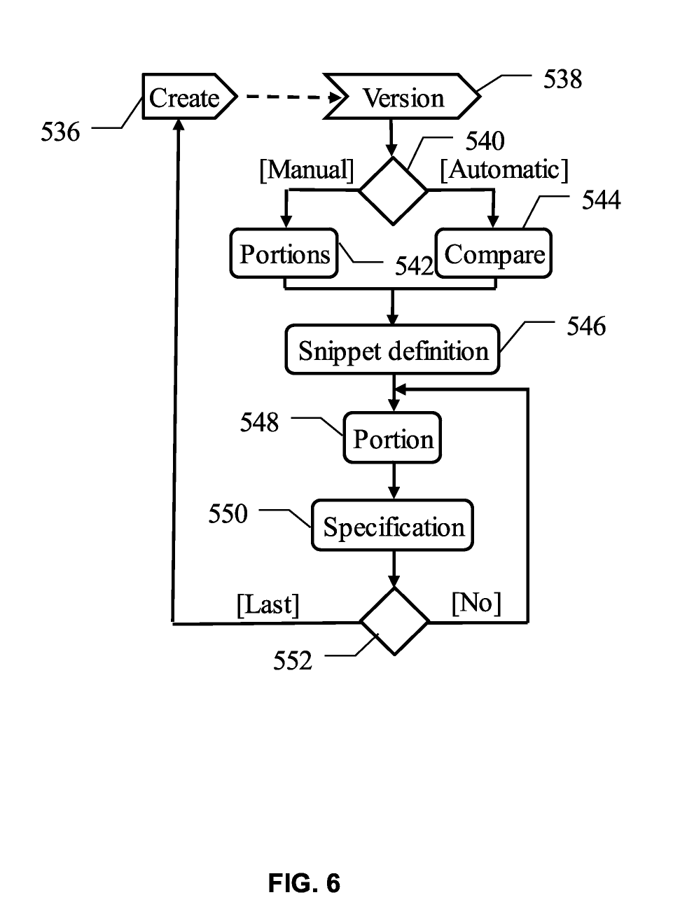

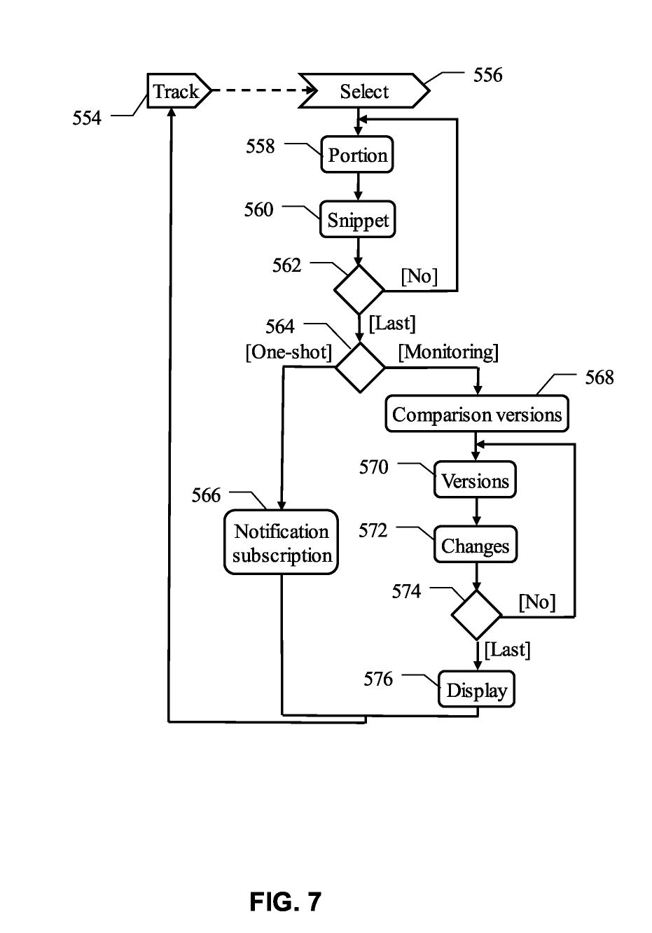

FIG. 5, FIG. 6, and FIG. 7, illustrate an activity diagram is shown describing the flow of activities relating to an implementation of a revision control system according to an embodiment of the present invention. In some embodiments, the diagram represents an exemplary process that may be used to manage changes to a generic software program with a method 500. Each block of the diagram may correspond to one or more executable instructions for implementing the specified logical function on the above-mentioned personal computer.

The process passes from block 502 to block 504 as soon the detector of the tracking engine detects the uploading of a new version of the software program into the revision control system, with its storing into the software program repository (for example, by means of hooking techniques). In some embodiments, the user may upload the first version directly or s/he may retrieve a working copy of a previous version from the software program repository (by checking-out it), modify this working copy and then upload the resulting next version (by checking-in or committing it). The first version may be stored integrally, whereas each next version is compared with the corresponding previous version by diff techniques to determine its change set (i.e., any artefact that has been modified, deleted or added) and this change set is then stored. In response thereto, the detector causes the analyzer of the tracking engine to analyze the version to determine its snippets that are compliant with corresponding snippet definitions. For example, the snippet definitions comprise one or more snippet definitions for routine declarations (like procedures, functions, methods), one or more snippet definitions for variable declarations (like global variable declarations of classes) and one or more snippet definitions for programming constructs (like conditional expressions, cycles). The flow of activity branches at block 506 according to the type of version that has been uploaded. The blocks 508-510 may be executed for the first version whereas the blocks 512-534 are executed for each next version.

The block 508 is a first version. The analyzer may assign an identifier to each snippet, where the identifier is unique for all the versions of the software program; particularly, for each snippet formed by a single artefact (for example, a variable declaration) the identifier comprises a (unique) single tag that is assigned to this artefact. For each snippet that is formed by a plurality of artefacts from a start artefact to an end artefact (for example, the heading and the exit of a routine declaration or the start keyword and the end keyword of a programming construct) the identifier may include a (unique) start tag and a (unique) end tag that are assigned to the start artefact and to the end artefact, respectively. In a possible implementation, each snippet is assigned a (simple) name. For example, the name of the snippet may be defined by the name of the routine, the name of the variable or the type of the programming construct (like if, or while) followed by a progressive number.

Each tag is then formed by the concatenation of different elements separated by a special symbol (like ::); more specifically, the tag indicates (in succession) a unique identifier of a module comprising the snippet (for example, full name of its file or class), the names in succession of each other snippet (if any) comprising this snippet, a keyword corresponding to the snippet definition (for example, routineStart/routineEnd for the start/end of routine declarations, varDeclaration for variable declarations, ifStart/ifEnd for the start/end of if-then programming constructs, whileStart/whileEnd for the start/end of while programming constructs) and the name of the snippet. This convention ensures the uniqueness of the tags; moreover, it creates a hierarchical structure (wherein the tag of each snippet directly enclosed within another snippet depends on its tag). Continuing to block 510, the analyzer stores the digest of the first version as defined by its snippets into the snippet repository; for example, the digest of the first version is represented by an ordered list of its tags. The process then returns to the block 502 waiting for the uploading of a further new version.

Considering now block 512 (next version), the analyzer compares the snippets of the next version with the snippets of its previous version; for this purpose, the analyzer enters a loop by taking into account a (current) snippet of the previous version (starting from the first one). Continuing to block 514, the analyzer verifies whether this snippet of the previous version has a corresponding snippet in the next version; for this purpose, two snippets are deemed corresponding when they are of the same type (i.e., compliant with the same snippet definition) and they have a high degree of similarity. For example, to be corresponding two snippets should at first be both routine declarations, variable declarations or the same programming constructor (like if-then or while); moreover, two snippets for the routine declarations should declare a similar routine (for example, with the same name and/or a percentage of equal statements higher than a threshold, such as 70-80%), two snippets for the variable declarations should declare the same variable (for example, with the same name), whereas two snippets for the same programming constructor should define a similar logic (for example, with the same condition and/or a percentage of equal statements higher than a threshold, such as 70-80%).

If a snippet of the next version corresponding to the snippet of the previous version has been found, the analyzer at block 516 assigns the same tag(s) of the snippet of the previous version to the snippet of the next version. Conversely, if the snippet of the previous version has no corresponding snippet in the next version, the analyzer at block 518 sets the tag(s) of the snippet of the previous version as deleted in the next version (so as to avoid reusing it). In both cases, the process then descends into block 520. At this point, the analyzer verifies whether a last snippet of the previous version has been processed. If not, the flow of activity returns to the block 512 to repeat the same operations on a next snippet of the previous version.

In other embodiments, the loop may be ended by proceeding into block 522; at this point, the analyzer determines each snippet of the next version (if any) that has been added to the previous version (i.e., it has not been found to correspond to any snippet of the previous version in the above-described loop). Continuing to block 524, the analyzer assigns a new (unique) identifier, i.e., one or two new (unique) tags, to each added snippet (according to the same convention as above). Continuing to block 526, the analyzer stores the digest of the next version as represented by its snippets into the snippet repository; in this way, a direct link is automatically created between each snippet of the next version and the corresponding snippet in each previous version (if any).

Moving to block 528, the comparator performs a loop for processing the notification subscriptions to the software program. For this purpose, the comparator verifies whether any notification subscription exists (as indicated in the notification subscription repository), and if so whether any notification subscription is still to be processed. In the affirmative case, the comparators at block 530 takes into account a (current) notification subscription (starting from a first one in any arbitrary order). Continuing to block 532, the comparator determines one or more (further) selected changes between the snippets of the next version and the snippets of its previous version corresponding to the (further) selected snippets of the notification subscription (as indicated in the notification subscription repository). For example, the selected changes are determined by simply extracting them from the change set between the next version and the previous version stored in the software program repository.

With reference now to block 534, the transmitter of the tracking engine notifies these selected changes to the corresponding user (as indicated in the notification subscription repository); for example, the notification is performed via e-mail, and it comprises a list of the selected changes (with an indication of each artefact that has been modified, deleted or added), and for each selected change the person who made the selected change and when it was made. In this way, the user is kept up-to-date (almost in real-time) about any changes to the software program relating to an aspect of interest to him/her, and s/he may proactively review these changes to verify their correctness (for example, to avoid the injection of defects or any undesired side effects). The process then returns to the block 528 to verify again whether any further notification subscription is still to be processed. As soon as all the notification subscriptions have been processed, or immediately when no notification subscription exists, the loop is exit and the process returns to the block 502 waiting for the uploading of a further new version.

In some embodiments, the process passes from block 536 to block 538 as soon as a user submits a request for creating a (custom) snippet definition by selecting a corresponding command in the user interface of the tracking engine. In response thereto, the user interface prompts the user to select a version (for example, the last version by default). The flow of activity then branches at block 540 according to the type of this creation request. Particularly, if the user has submitted a request for a manual creation of the custom snippet definition, the user interface at block 542 prompts the user to select one or more (definition) portions of the selected version to be used to create the snippet definition (for example, in a corresponding GUI); for example, the definition portions may be portions of the software program relating to the implementation of a specific feature whose changes are to be tracked. Conversely, if the user has submitted a request for an automatic creation of the custom snippet definition, the comparator at block 544 compares the selected version with its previous version (assuming that the selected version is not the first version) in order to determine any (added) portion of the selected version that has been added to the previous version; for example, the added portions may relate to the implementation of a new feature that has been provided in the selected version.

In both cases, the flow of activity merges again at block 546 (from either the block 542 or the block 544). At this point, the analyzer adds a new snippet definition of the custom type to the snippet definition repository; for example, the new snippet definition is assigned a name defined by a dedicated keyword (like custom) followed by a progressive number. The analyzer then enters a loop at block 548 for processing the definition/added portions; the loop begins by taking into account a (current) definition/added portion (starting from the first one of each file in any arbitrary order). Continuing to block 550, the analyzer adds a (portion) specification of the definition/added portion to the custom snippet definition. Particularly, if the definition/added portion is formed by a single artefact it is specified by this artefact; conversely, if the definition/added portion is formed by a plurality of artefacts it is specified by its start artefact and its end artefact. Moreover, in case of multiple definition/added portions, a (unique) index is assigned to the portion specification (for example, a progressive number within the custom snippet definition). The analyzer then verifies at block 552 whether a last definition/added portion has been processed. If not, the flow of activity returns to the block 548 to perform the same operations for a next definition/added portion. Conversely, once all the definition/added portions have been processed, the loop is exit and the process returns to the block 536 waiting for a further request of creating a custom snippet definition. Any custom snippet definition is then used like the other (standard) snippet definitions to identify the corresponding snippets. In this case, each snippet compliant with a custom snippet definition comprises one or more (snippet) components; each snippet component is formed by a portion of the corresponding version that is compliant with a corresponding portion specification of the custom snippet definition.

Each snippet component is assigned a (unique) identifier; particularly, the identifier comprises a (unique) single tag for a portion specification of a single artefact or a (unique) start tag and a (unique) end tag for a portion specification of a plurality of artefacts. In a possible implementation, the snippet component is assigned a (simple) name, which is defined by the name of the custom snippet definition followed by the index of the portion specification; each tag is then formed by the concatenation of the unique identifier of the module comprising the snippet portion, the names in succession of each other snippet (if any) comprising the snippet portion, a keyword corresponding to the custom snippet definition (for example, custom for a portion specification of a single artefact or customStart/customEnd for a portion specification of multiple artefacts) and the name of the snippet component (again to ensure the uniqueness of the tags and to create a hierarchical structure).

In some embodiments, the process passes from block 554 to block 556 as responsive to a user submitting a request for tracking changes of interest by selecting a corresponding command in the user interface of the tracking engine. In response thereto, the user interface prompts the user to select a version (for example, the last version by default) and then one or more portions thereof (with example, in the same GUI as above). The expander then enters a loop at block 558 for processing these selected portions; the loop begins by taking into account a (current) selected portion (starting from the first one of each file in any arbitrary order). Continuing to block 560, the expander determines the corresponding selected snippet (directly enclosing it). The selected snippet is determined immediately when the selected portion corresponds thereto. Otherwise, the selected portion is expanded until it corresponds to a snippet; particularly, the selected portion is expanded upwards and downwards until a start artefact and an end artefact, respectively, of a same snippet is reached. The expander then verifies at block 562 whether a last selected portion has been processed. If not, the flow of activity returns to the block 558 to perform the same operations for a next selected portion. Conversely, once all the selected portions have been processed, the loop is exit by descending into block 564.

At this point, the flow of activity branches according to the type of the tracking request. Particularly, if the user has submitted a request for monitoring the changes to the software program, the process passes from the block 564 to block 566, wherein the expander adds a corresponding (new) notification subscription to the notification subscription repository; the new notification subscription comprises an indication of the selected snippets and an indication of a notification address of the user (either entered by him/her through the user interface or set to a general notification address of the user provided in a corresponding profile). The process then returns to the block 554 waiting for a further request of tracking changes to the software program.

Conversely, if the user has submitted a request for a one-shot inspection of the changes to the software program, the process passes from the block 564 to block 568, wherein the user interface prompts the user to select the comparison versions (all the versions preceding the selected version by default). The comparator then enters a loop at block 570 for processing the comparison versions; the loop begins by taking into account a (current) next version and a (current) previous version (with the next version set to the selected version and the previous version set to the closest comparison version that precedes the selected version at the beginning). Continuing to block 572, the comparator determines one or more selected changes between the snippets of the next version and the snippets of the previous version corresponding to the selected snippets (for example, again by extracting them from the corresponding change set stored in the software program repository). The comparator then verifies at block 574 whether a last comparison version has been processed. If not, the flow of activity returns to the block 570 to perform the same operations for a next comparison version.

The (new) next version may be set to the (current) previous version and the (new) previous version is set to the closest comparison version that precedes the new next version, if any; otherwise, once all the comparison versions preceding the selected version have been processed, at the beginning the (new) preceding version is set to the selected version and the (new) next version is set to the closest comparison version that follows the selected version, and later on the (new) previous version is set to the (current) next version and the (new) next version is set to the closest comparison version that follows the new previous version, if any. In some embodiments, responsive to the comparison versions having been processed, the loop is exit by descending into block 576. At this point, the user interface displays the selected changes to the user (for example, in the same GUI as above). In this way, the user may have an overview of the history of all the changes of interest in an efficient and friendly way, an s/he may easily navigate through them (for example, to display additional information relating thereto extracted from the software program repository, like the person who made each change and when it was made). The process then returns to the block 554 waiting for a further request of tracking changes to the software program.

In some embodiments, the revision control system 405 is a computer-implemented method that includes identifying a document, the document are accessible to a revision control system, identifying at least two document versions, the at least two document versions are for the document, the at least two document versions are accessible to the revision control system, receiving a plurality of critical artefacts, parsing each of the at least two document versions for the plurality of critical artefacts to yield a critical artefact table for each of the at least two document versions, comparing the critical artefact table for a first version of the at least two document versions with the critical artefact table for a second version of the at least two document versions, identifying one or more corresponding critical artefacts, the one or more corresponding critical artefacts are referenced from both the critical artefact table for the first version and the critical artefact table for the second version, comparing each of the at least two document versions to yield a set of differences between the at least two document versions; and organizing the set of differences between the at least two document versions based on the one or more corresponding critical artefacts.

Critical artefacts are code expressions of a computer programming language. For example, critical artefacts may be methods, functions, if statements, else statements, while loops, for loops, switch commands, and/or global variable definitions. In some embodiments, whether an artefact is a critical artefact is determined responsive to user input. Critical artefact tables are any data structures that include a critical artefact. A data structure is any way of organizing data within or for use by a computer such that the data can be used efficiently. For example, the critical artefact table may be an array, a list, or a set.

In some embodiments, parsing each of the two document versions for the plurality of critical artefacts to yield a critical artefact table for each of the at least two document versions comprises, for each critical artefact of the critical artefact table, assigning a tag the tag comprising an identifier.

In some embodiments, the document comprises source code for a computer software program, the source code are expressed in a computer programming language. In some embodiments, each of the plurality of critical artefacts comprise one or more code expressions for the computer programming language selected from a list consisting of:
(a) methods;
(b) functions;
(c) if statements;
(d) else statements;
(e) while loops;
(f) for loops;
(g) switch commands; and
(h) global variable definitions.

In some embodiments, receiving a plurality of critical artefacts is responsive to input from a user. In some embodiments, identifying one or more corresponding critical artefacts is responsive to input identifying a current document version, the current document version are one of the at least two document versions.

In some embodiments, the revision control system 405 includes computer program instructions to identify a document, the document are accessible to a revision control system, identify at least two document versions, the at least two document versions are for the document, the at least two document versions are accessible to the revision control system, receive a plurality of critical artefacts, parse each of the at least two document versions for the plurality of critical artefacts to yield a critical artefact table for each of the at least two document versions, compare the critical artefact table for a first version of the at least two document versions with the critical artefact table for a second version of the at least two document versions, identify one or more corresponding critical artefacts, the one or more corresponding critical artefacts are referenced from both the critical artefact table for the first version and the critical artefact table for the second version, compare each of the at least two document versions to yield a set of differences between the at least two document versions; and organize the set of differences between the at least two document versions based on the one or more corresponding critical artefacts.

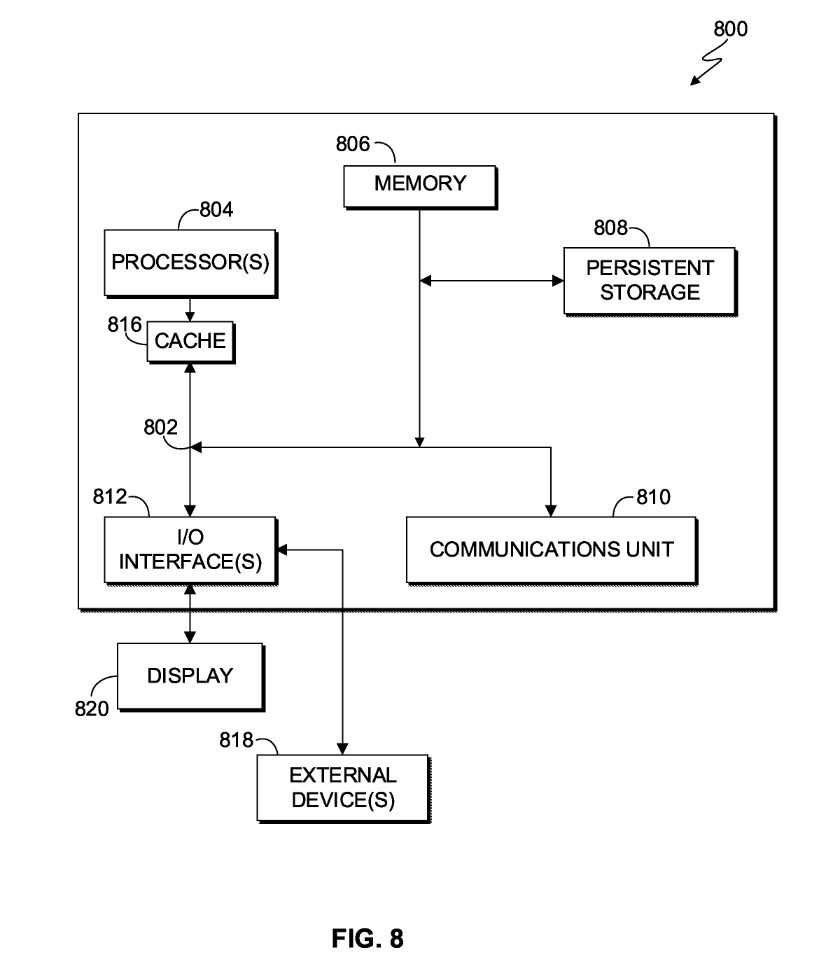

FIG. 8 is a block diagram depicting components of a computer 800 suitable for executing the revision control system 405. FIG. 8 displays the computer 800, the one or more computer processor(s) 804 (including one or more computer processors), the communications fabric 802, the memory 806, the RAM, the cache 816, the persistent storage 808, the communications unit 810, the I/O interface(s) 812, the display 820, and the external devices 818. It should be appreciated that FIG. 8 provides only an illustration of one embodiment and does not imply any limitations with regard to the environments in which different embodiments may be implemented. Many modifications to the depicted environment may be made.

As depicted, the computer 800 operates over a communications fabric 802, which provides communications between the cache 816, the computer processor(s) 804, the memory 806, the persistent storage 808, the communications unit 810, and the input/output (I/O) interface(s) 812. The communications fabric 802 may be implemented with any architecture suitable for passing data and/or control information between the computer processor(s) 804 (e.g. microprocessors, communications processors, and network processors, etc.), the memory 806, the external devices 818, and any other hardware components within a system. For example, the communications fabric 802 may be implemented with one or more buses or a crossbar switch.

The memory 806 and persistent storage 808 are computer readable storage media. In the depicted embodiment, the memory 806 includes a random access memory (RAM). In general, the memory 806 may include any suitable volatile or non-volatile implementations of one or more computer readable storage media or one or more computer readable media. The cache 816 is a fast memory that enhances the performance of computer processor(s) 804 by holding recently accessed data, and data near accessed data, from memory 806.

Program instructions for the revision control system 405 may be stored in the persistent storage 808 or in memory 806, or more generally, any computer readable storage media, for execution by one or more of the respective computer processor(s) 804 via the cache 816. The persistent storage 808 may include a magnetic hard disk drive. Alternatively, or in addition to a magnetic hard disk drive, the persistent storage 808 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 808 may also be removable. For example, a removable hard drive may be used for persistent storage 808. Other examples include optical and magnetic disks, thumb drives, and smart cards that are inserted into a drive for transfer onto another computer readable storage medium that is also part of the persistent storage 808.

The communications unit 810, in these examples, provides for communications with other data processing systems or devices. In these examples, the communications unit 810 may include one or more network interface cards. The communications unit 810 may provide communications through the use of either or both physical and wireless communications links. The revision control system 405 may be downloaded to the persistent storage 808 through the communications unit 810. In the context of some embodiments of the present invention, the source of the various input data may be physically remote to the computer 800 such that the input data may be received and the output similarly transmitted via the communications unit 810.

The I/O interface(s) 812 allows for input and output of data with other devices that may operate in conjunction with the computer 800. For example, the I/O interface(s) 812 may provide a connection to the external devices 818, which may include a keyboard, keypad, a touch screen, and/or some other suitable input devices. External devices 818 may also include portable computer readable storage media, for example, thumb drives, portable optical or magnetic disks, and memory cards. Software and data used to practice embodiments of the present invention may be stored on such portable computer readable storage media and may be loaded onto the persistent storage 808 via the I/O interface(s) 812. The I/O interface(s) 812 may similarly connect to a display 820. The display 820 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as are transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a document, said document being accessible to a revision control system;
identifying at least two document versions, said at least two document versions being for said document, said at least two document versions being accessible to said revision control system;
receiving a plurality of critical artefacts;
parsing each of said at least two document versions for said plurality of critical artefacts to yield a critical artefact table for each of said at least two document versions;
comparing said critical artefact table for a first version of said at least two document versions with said critical artefact table for a second version of said at least two document versions;
identifying one or more corresponding critical artefacts, said one or more corresponding critical artefacts being referenced from both said critical artefact table for said first version and said critical artefact table for said second version;
comparing each of said at least two document versions to yield a set of differences between said at least two document versions; and
organizing said set of differences between said at least two document versions based on said one or more corresponding critical artefacts.

2. The computer-implemented method of claim 1, wherein:
parsing each of said two document versions for said plurality of critical artefacts to yield a critical artefact table for each of said at least two document versions comprises, for each critical artefact of said critical artefact table, assigning a tag said tag comprising an identifier.

3. The computer-implemented method of claim 1, wherein said document comprises source code for a computer software program, said source code being expressed in a computer programming language.

4. The computer-implemented method of claim 3, wherein each of said plurality of critical artefacts comprise one or more code expressions for said computer programming language selected from a list consisting of:
(a) methods;
(b) functions;
(c) if statements;
(d) else statements;
(e) while loops;
(f) for loops;
(g) switch commands; and
(h) global variable definitions.

5. The computer-implemented method of claim 1, wherein receiving a plurality of critical artefacts is responsive to user input.

6. The computer-implemented method of claim 1, wherein identifying one or more corresponding critical artefacts is responsive to input identifying a current document version, said current document version being one of said at least two document versions.

7. A computer program product comprising:
one or more computer readable storage media and program instructions stored on said one or more computer readable storage media, said program instructions comprising instructions to:
identify a document, said document being accessible to a revision control system;
identify at least two document versions, said at least two document versions being for said document, said at least two document versions being accessible to said revision control system;
receive a plurality of critical artefacts;
parse each of said at least two document versions for said plurality of critical artefacts to yield a critical artefact table for each of said at least two document versions;
compare said critical artefact table for a first version of said at least two document versions with said critical artefact table for a second version of said at least two document versions;
identify one or more corresponding critical artefacts, said one or more corresponding critical artefacts being referenced from both said critical artefact table for said first version and said critical artefact table for said second version;
compare each of said at least two document versions to yield a set of differences between said at least two document versions; and
organize said set of differences between said at least two document versions based on said one or more corresponding critical artefacts.

8. The computer program product of claim 7, wherein:
instructions to parse each of said two document versions for said plurality of critical artefacts to yield a critical artefact table for each of said at least two document versions comprises and, for each critical artefact of said critical artefact table, instructions to assign a tag said tag comprising an identifier.

9. The computer program product of claim 7, wherein said document comprises source code for a computer software program, said source code being expressed in a computer programming language.

10. The computer program product of claim 9, wherein each of said plurality of critical artefacts comprise one or more code expressions for said computer programming language selected from a list consisting of:
(a) methods;
(b) functions;
(c) if statements;
(d) else statements;
(e) while loops;
(f) for loops;
(g) switch commands; and
(h) global variable definitions.

11. The computer program product of claim 7, wherein said instructions to receive a plurality of critical artefacts is responsive to user input.

12. The computer program product of claim 7, wherein said instructions to identify one or more corresponding critical artefacts are performed responsively to input identifying a current document version, said current document version being one of said at least two document versions.

13. A computer system comprising:
one or more computer processors;
one or more computer readable storage media;
computer program instructions; and
said computer program instructions being stored on said computer readable storage media for execution by at least one of said one or more processors, said computer program instructions comprising instructions to:
identify a document, said document being accessible to a revision control system;
identify at least two document versions, said at least two document versions being for said document, said at least two document versions being accessible to said revision control system;
receive a plurality of critical artefacts;
parse each of said at least two document versions for said plurality of critical artefacts to yield a critical artefact table for each of said at least two document versions;
compare said critical artefact table for a first version of said at least two document versions with said critical artefact table for a second version of said at least two document versions;
identify one or more corresponding critical artefacts, said one or more corresponding critical artefacts being referenced from both said critical artefact table for said first version and said critical artefact table for said second version;
compare each of said at least two document versions to yield a set of differences between said at least two document versions; and
organize said set of differences between said at least two document versions based on said one or more corresponding critical artefacts.

14. The computer system of claim 13, wherein:
instructions to parse each of said two document versions for said plurality of critical artefacts to yield a critical artefact table for each of said at least two document versions comprises, for each critical artefact of said critical artefact table, instructions to assign a tag said tag comprising an identifier.

15. The computer system of claim 13, wherein said document comprises source code for a computer software program, said source code being expressed in a computer programming language.

16. The computer system of claim 15, wherein each of said plurality of critical artefacts comprise one or more code expressions for said computer programming language selected from a list consisting of:
(a) methods;
(b) functions;
(c) if statements;
(d) else statements;
(e) while loops;
(f) for loops;
(g) switch commands; and
(h) global variable definitions.

17. The computer system of claim 13, wherein said instructions to receive a plurality of critical artefacts is responsive to user input.

18. The computer system of claim 13, wherein instructions to identify one or more corresponding critical artefacts is responsive to input identifying a current document version, said current document version being one of said at least two document versions.
